(19) United States
(12) Patent Application Publication
(10) Pub. No.: US 2016/0087971 A1
(43) Pub. Date: Mar. 24, 2016

(54) Method And System For Generating Identification And Certification Of E-License

(71) Applicant: ID Security Experts Inc., Burnaby (CA)

(72) Inventor: David F. Campbell, Maple Ridge (CA)

(21) Appl. No.: 14/616,637

(22) Filed: Feb. 6, 2015

(30) Foreign Application Priority Data
Sep. 23, 2014 (PL) P.409568

(51) Int. Cl. H04L 29/06; G06Q 20/32; H04B 5/00; G06Q 20/40; H04W 4/00; G06Q 20/14; G06Q 20/38

(52) U.S. Cl. CPC H04L 63/0823; H04L 63/083; H04L 63/0492; H04L 63/0869; G06Q 20/14; G06Q 20/3278; G06Q 20/3827; G06Q 20/401; H04W 4/008; H04B 5/0031; G06Q 2220/18

(57) ABSTRACT

A method and system for generating identification and certification of e-licenses includes the use of software, applications and mobile devices such as smartphones. It is designed to issue and manage all kinds of permits, e-licenses or other documents intended for identification and certification of specific documents and permits in any defined area.

### RELATED APPLICATIONS

This application claims priority to Polish Patent Application No. P.409568, filed Sep. 23, 2014, entitled Method And System For Generating Identification And Certification Of E-License, which is hereby incorporated herein by reference in its entirety.

### FIELD OF THE INVENTION

The present invention relates to a method and system for generating identification and certification of e-licenses, and includes the use of software, applications and mobile devices such as smartphones. The present invention is designed to issue and manage all kinds of permits, e-licenses or other documents intended for identification and certification of specific documents and permits in any defined area.

### BACKGROUND OF THE INVENTION

An E-license or virtual license or permit should be understood as applying to any legal document or contract, issued by the relevant national, regional or local government bodies, as well as organizations and commercial associations confirming powers through such a document or contract. Such licenses include professional certificates which certify professional qualifications gained through a certification process, additional training, exams and often after proving the required expertise in professions of so called “public trust” which give the right to exercise the professions granted by professional unions.

A variety of ways to identify, issue and renew licenses and permits is known. For example, in Canada, in order to obtain a Chinook Stamp mark of authenticity and thereby obtain authorization for fishing in the saltwater in Canada, one has to go to the website of the Ministry of Fisheries and complete the registration form. After receiving the access code, it is possible to securely log into the system. This online registration method has been operating for more than three years.

After the application is filled out with the personal information and the type of license is selected, the user checks out to pay by credit card on line. Once this is approved the system sends to the user a picture of the license in standard paper size (8 ½″×11″) with detailed printing instructions. The downside of this process is that a fishing license printed on paper with water soluble inks will often disappear when wet. There is also the problem of the availability of a printer.

A way of creating a virtual badge is also known. For example, WO2014066016 (which is hereby incorporated by reference) discloses an electronic identifier for everyday use as well as for system response and disaster recovery. It combines a system, method and apparatus that provides an identifier or “badge” on the electronic device, such as a mobile device, as well as a separate, synchronized electronic display device.

A way of authenticating identity documents is also known. For example, WO2013138589 A1 (which is hereby incorporated by reference) discloses a portable hand-held device which includes computer-implemented instructions to emulate identity documents such as a passport and interact with a computer to determine whether such documents are authentic.

Currently, most authorization documents are paper documents. Using such paper documents requires the holder to systematically and manually enter a number of data, which is cumbersome. Moreover, current authorization documents do not always have safeguards to protect them against counterfeiting or have the ability to verify the correctness entries on the document.

This is exemplified in the specific area of fishing licenses and the requirement to record the date and place and number of a catch of fish, i.e., the data on the quantity of fish caught in a given season and the location of said catches. After filling in the table and printing a copy of such an authorizing document, rewriting the details of caught fish depends exclusively on the integrity of the card/license holder

### OBJECTS AND SUMMARY OF THE INVENTION

The solution according to the present invention is in the form of a method and system for generating identification and e-license certification using software, an application and mobile devices such as a smartphone or a computer. Communicating and managing the various components of the system in the certification process in accordance with the present invention solves the problems associated with the use and verification of traditional documents. It also automates the process of replacing any existing identification documents such as driver's license, identity card or any identity document issued in the traditional way, in the form of paper documents or plastic cards

### BRIEF DESCRIPTION OF THE DRAWINGS

These advantages are achieved with the present invention, which embodiments of the invention are capable of will be apparent and elucidated from the following description of embodiments of the present invention, reference being made to the accompanying drawings, in which

FIG. 1 is a flow diagram rendering of an embodiment of the present invention;

FIG. 2 is a flow diagram rendering of component modules in accordance with an embodiment of the present invention;

FIGS. 3-15 are screen shots of an application in accordance with an embodiment of the present invention

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

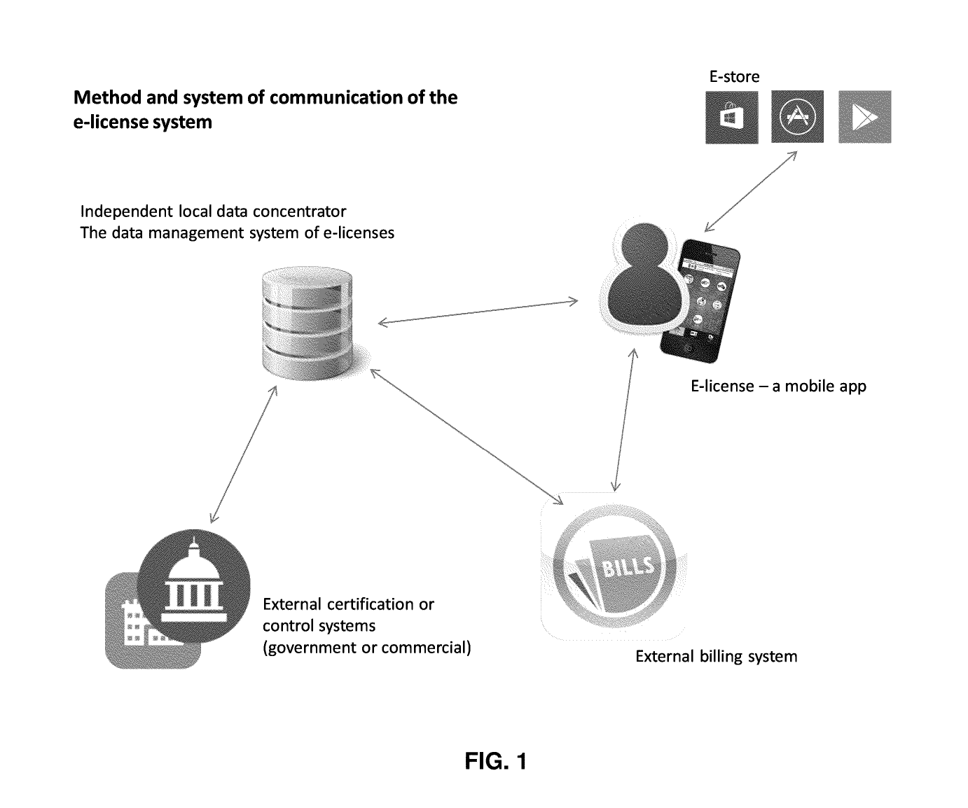

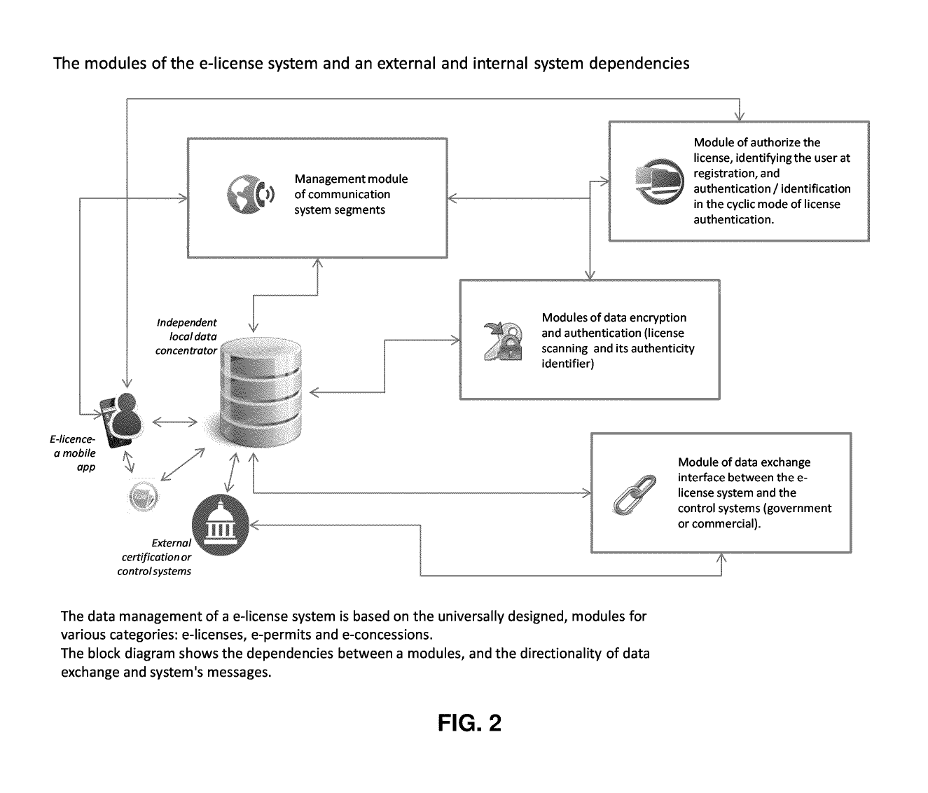

Referring to FIGS. 1 and 2, the system according to the invention is comprised of a data concentrator, a data management system, external certification systems, a billing system, and e-licenses in the form of an application installed on an external device, for example, a computer and/or smartphone.

In the system according to the invention, a number of communication solutions for the mutual exchange of information between the various system components is used. In one embodiment the system is equipped with: Bluetooth wireless technology for encrypted exchange of information with the control authorities; a GPS module designed to locate licensed areas by date and time; encryption algorithms to secure data; a username and password gateway to prevent unauthorized use; and an application information exchange interface between the reader, computer and control bodies and their database.

The system includes the modules responsible for the operation of individual elements of the system in the process of generating the identification and certification of e-license.

Referring to FIG. 2, There is a module of data exchange that uses Near Field Communication (NFC) technology, and technology such as two-dimensional code scanning, e.g. QR code using scanners in smartphones, to facilitate the transfer of data from the smartphone to the base of the control body (government or commercial) via the Internet at any time during a specified period. For example, with regard to fishing, the user activates the application and via touch screen selects one of the available fields on the screen indicating the allowed catch of a given species of fish. Each unchecked box contains both the exact date of catch, the size of the fish, the location based on the GPS display and automatic determination of the permitted fishing zone.

Referring to FIG. 2, there is a module for management of communication system segments which specifies the parameters of use and structure of applications and the type and protocol of the communication depending on the type of document (e.g., driver's license, hunting license, etc.). It manages the selection of the method of contact between the individual elements of the system, e.g. the authority controlling the validity of document or license. The module also controls the security features used in any type of e-license.

Referring to FIG. 2, there is also a data encryption and authentication module which serves to scan the license and its authenticity identifier. This module is based on secure algorithms and data technologies which use a unique secure identifier to facilitate the reading of information between mobile applications and the e-license issuer's databases. The license is scanned using NFC/RFID identifier using authentication to verify the validity of the license, adding security to automatic reading (including visual features such as a photograph, signature, etc.), and other security validation. Barcodes (through barcode readers), text messages, and e-mail with a secure protocol can be used as secure communication protocols.

Referring to FIG. 2, there is also an e-license authentication module which controls the application and serves to authorize the purchase of a license. Authentication occurs when a user registers in the system database in order to renew a license, using login and password protocols generated by an administrative body. At the time of purchase, the module reads the login and password data and then converts them to a new encrypted code that allows the administrative body to convert the license data in real time, as the true and secure license of its holder. A user photo placed optionally in the application data, accelerates the process of license verification during inspection. The inspection body may also scan the barcode for authentication of the license number using encryption protocol used during awarding the license number. This protocol also controls the re-release of the license, in case of loss or damage of its paper version, using the original license numbers, numbers of licenses associated with the assigned additional numbers in the course of generation of the electronic license. This allows for secure authentication of the user's license number.

The system according to the invention is shown in the accompanying FIG. 1 where the system is composed of a data concentrator, i.e., a data management system, external certification systems, a billing system, an e-license application which is installed on an external device, for example on a computer and/or smartphone.

Features, components and operation of the system are shown and described with respect to an embodiment of the invention intended for certification of fishing. The screen views in the application are described as follows:

HOME—displays the startup screen visible after logging into the application. All the features of the application are navigated from here.

LICENSES/PERMITS—the screen where you see all the information relating to the angler's profile including the license number, valid authenticity features, the date of license purchase and the period of validity.

PROFILE—displays all the profiles of the license holder. You can decide which profile applies to a catch and control.

LIST OF FISH CATCH containing different species—contains a table for entering each fish caught. When you touch the specific location module on the screen with your finger, the GPS automatically assigns the catch area also the date and time are recorded. It is also possible to enter this information manually. If you specify the location of catches a built-in map may be helpful.

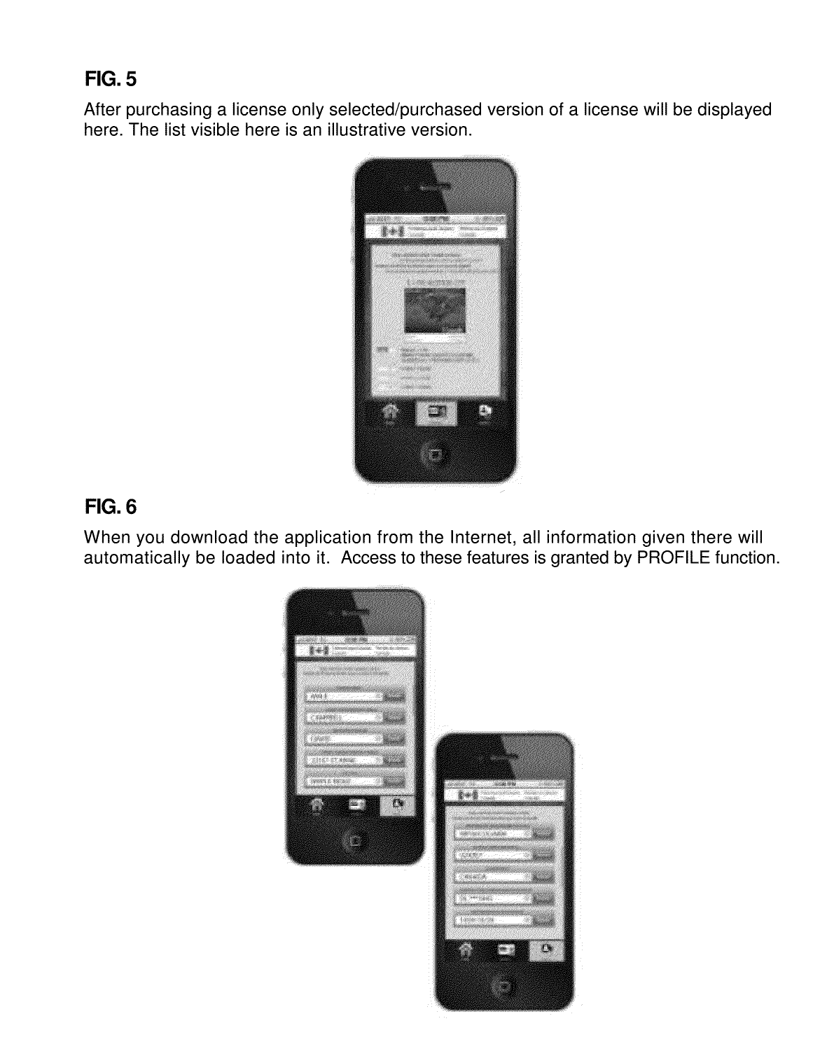

SCAN LICENSE/PERMIT—click refers to the screen of FIG. 5. During a routine inspection, a guard scans the designated angler's profile which automatically transmits such angler's personal details and lists of catch to the guard's hand-held device and the main computer on the land. Option—scan the license—the QR code contains all the lists of catch and personal details and a license number refers to the map of fishing areas and fisheries.

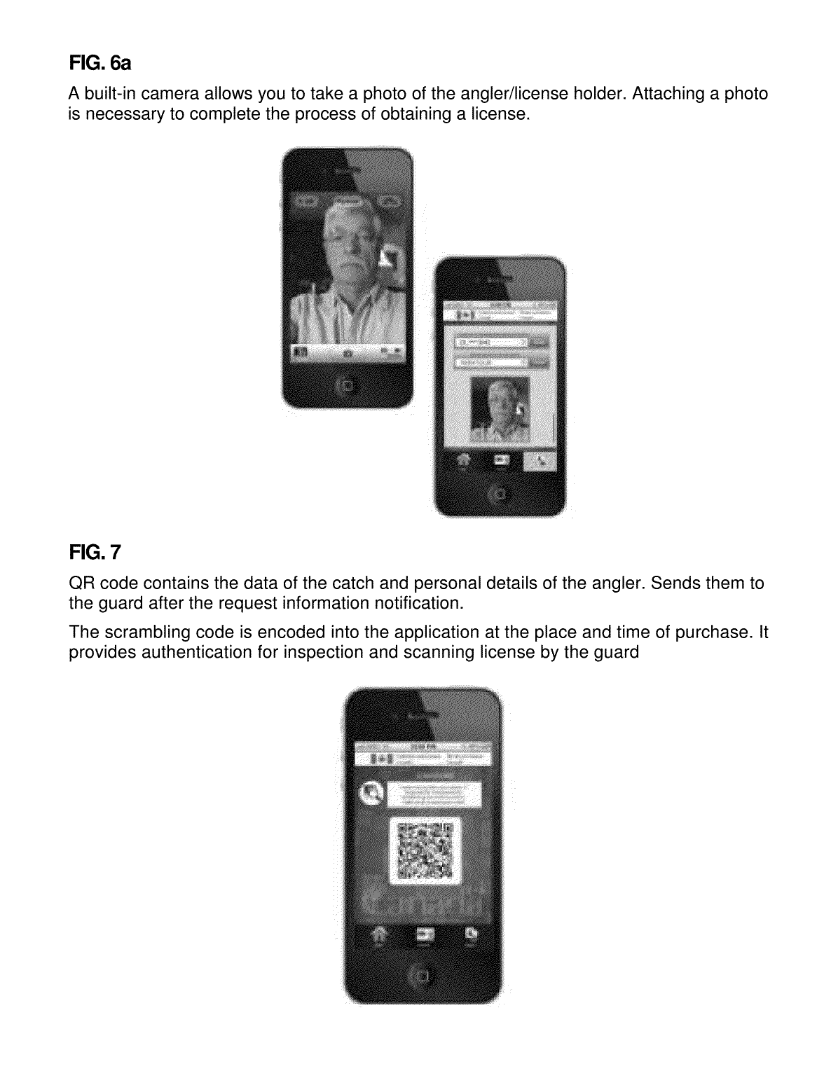

LOCATOR—click refers to the screen of FIG. 6. The GPS function accurately locates the angler and gives his catch area. Such locating is for informational purposes only and together with the number of fishing zones provides legislation in force on such territory.

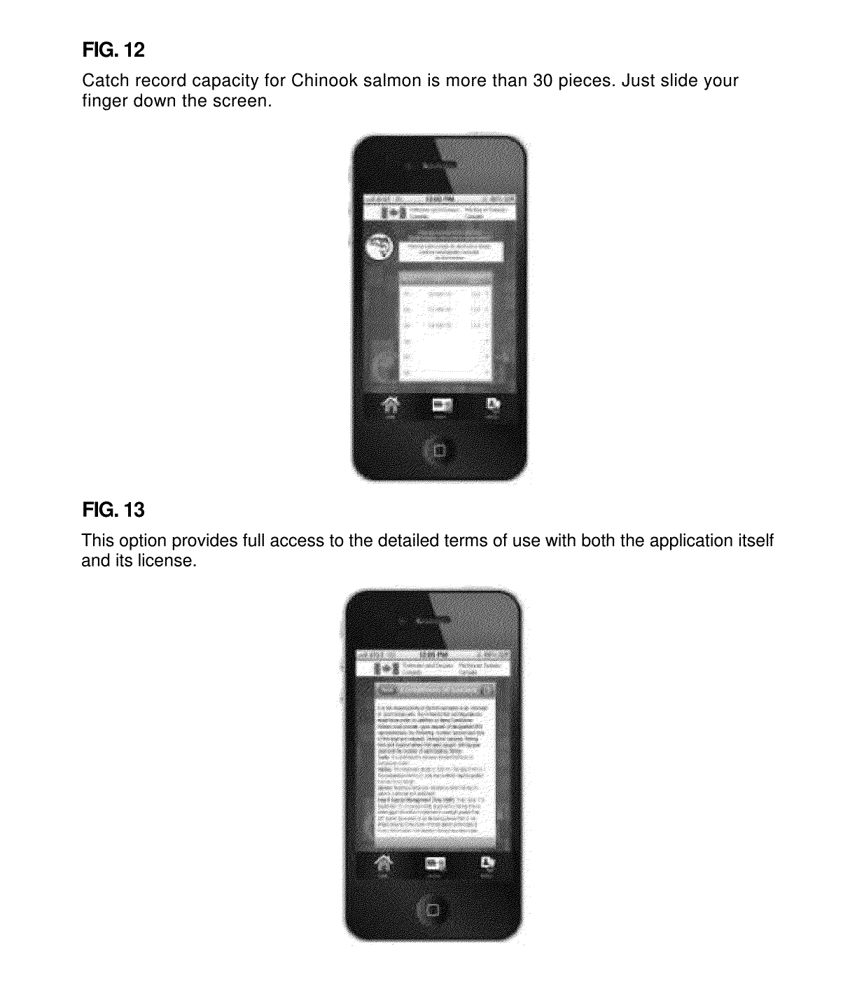

RULES AND REGULATIONS—click refers to the screen of FIG. 12. Opens the document online here in PDF format—quick link to the applicable regulations of the Ministry of Fisheries or other bodies of similar relevance.

TRANSMIT CATCH RECORDS—click refers to the screen of FIG. 7. Tips Shown here navigate user on how to transfer the current lists of catch directly to the Ministry of Fisheries or other body of similar relevance, thus allowing monitoring of catches (including the catch area, species and quantity of fish caught) in real time.

REPORT ABUSE—click refers to the screen of FIG. 13. This feature allows immediate notification of the Ministry of Fisheries or other body of similar relevance of abuse, or breaking the law observed on the water or shore.

After the end of each trip, information, updated on the day the application was used and containing the type and amount of fish caught for the day are converted to the so-called two-dimensional code. QR code, constituting a summary of the day's catch that contains information about the quantity, size of the fish and location of the catch area and then transferred to the control authorities with the communication protocol of a smartphone. For example, towards the end of the season, when the user ends fishing and verifies the process of renewal of the license for another year, the application moves the data of the current season to the general census of fisheries. Through this process the update information of fisheries are completed in real time.

The invention in detail is shown in the example of fishing license certification documents—a fishing license, entitling the user to catch some fish species, allowing downloading and storing a license on the user's smartphone.

List for catching fish, consecutively—touch function, GPS will open a window to the areas of fishing, enter the number of the captured fish, the date will autofill. With this function, the user can easily transfer data directly to the Ministry of Fisheries or other body of similar relevance, which will update the catch statistics in the country at any time, create Chinook salmon catch record on the date, the number of fish caught and their size. Touch this feature and a GPS will open a window with the areas of fishing, enter the quantity of caught fish and their size in accordance with the regulations. Just touch a number indicating the number of captured pieces and pre-calculated dimensions that appears on the screen. The fishing area location with GPS function automatically reads latitudes as specific fishing zones. GPS is also available without a telecommunication network coverage.

If the GPS is not working, you can find your zone catch on your smartphone's built-in map and mark the fish zone number.

Checking the authenticity of licenses is done by scanning the license and its identity authentication occurs during an inspection by a guard. The encrypted data is transmitted through proximity communication, Bluetooth, RFID or adjacent device—built-in a smartphone depending on the method chosen by the user.

The method of operation illustrated in the example of the function and properties of the application/system is now discussed.

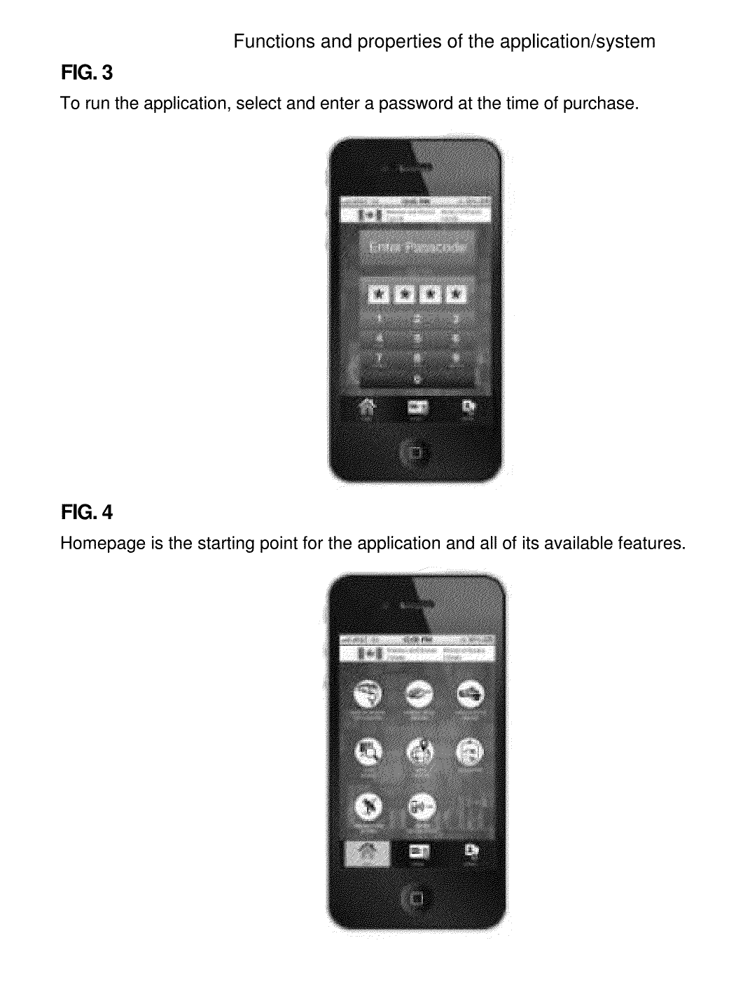

FIG. 3: To run the application, select and enter a password at the time of purchase.

FIG. 4: Homepage is the starting point for the application and all of its available features.

FIG. 5: After purchasing a license, only the selected/purchased version of a license will be displayed here. The list visible in FIG. 3 is an illustrative version.

FIG. 6: When you download the application from the Internet, all information given there will automatically be loaded into the application. Access to these features is granted by the PROFILE function.

FIG. 6a: A built-in camera allows you to take a photo of the angler/license holder. Attaching a photo is necessary to complete the process of obtaining a license.

FIG. 7: A Quick Response or “QR” code contains the data of the catch and personal details of the angler. The application sends them to the guard after the request information notification. The scrambling code is encoded into the application at the place and time of purchase. It provides authentication for inspection and scanning license by the guard.

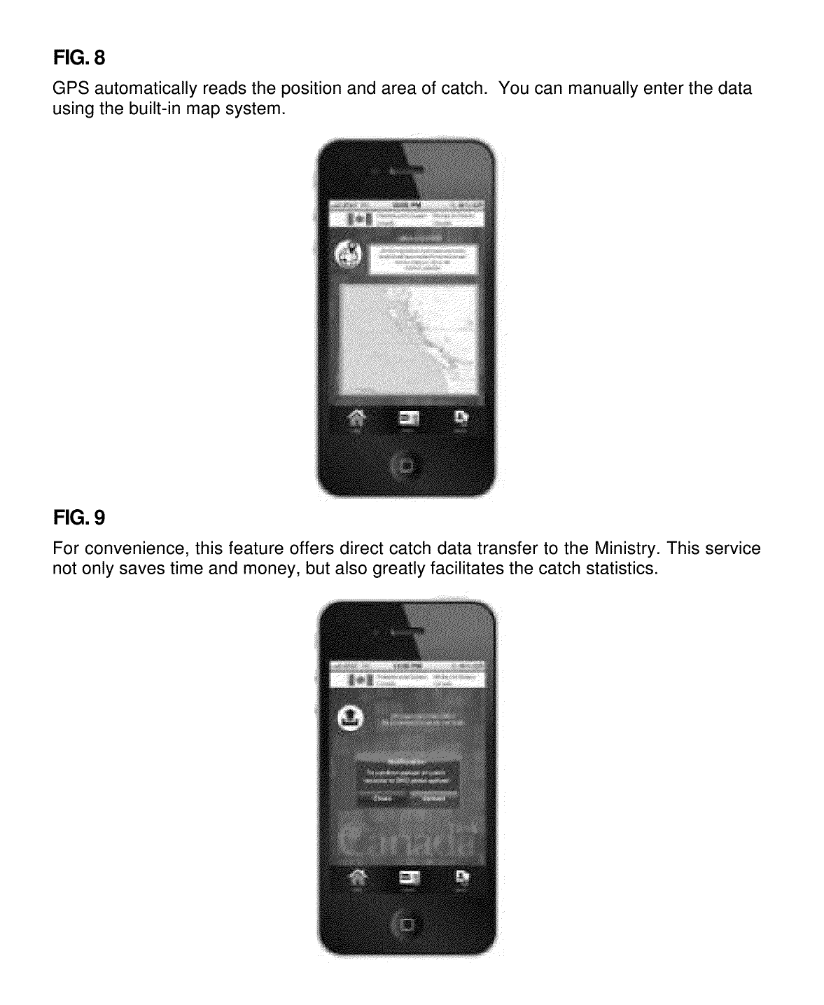

FIG. 8: A GPS automatically reads the position and area of catch. You can manually enter the data using the built-in map system.

FIG. 9: For convenience, this feature offers direct catch data transfer to the Ministry. This service not only saves time and money, but also greatly facilitates the catch statistics.

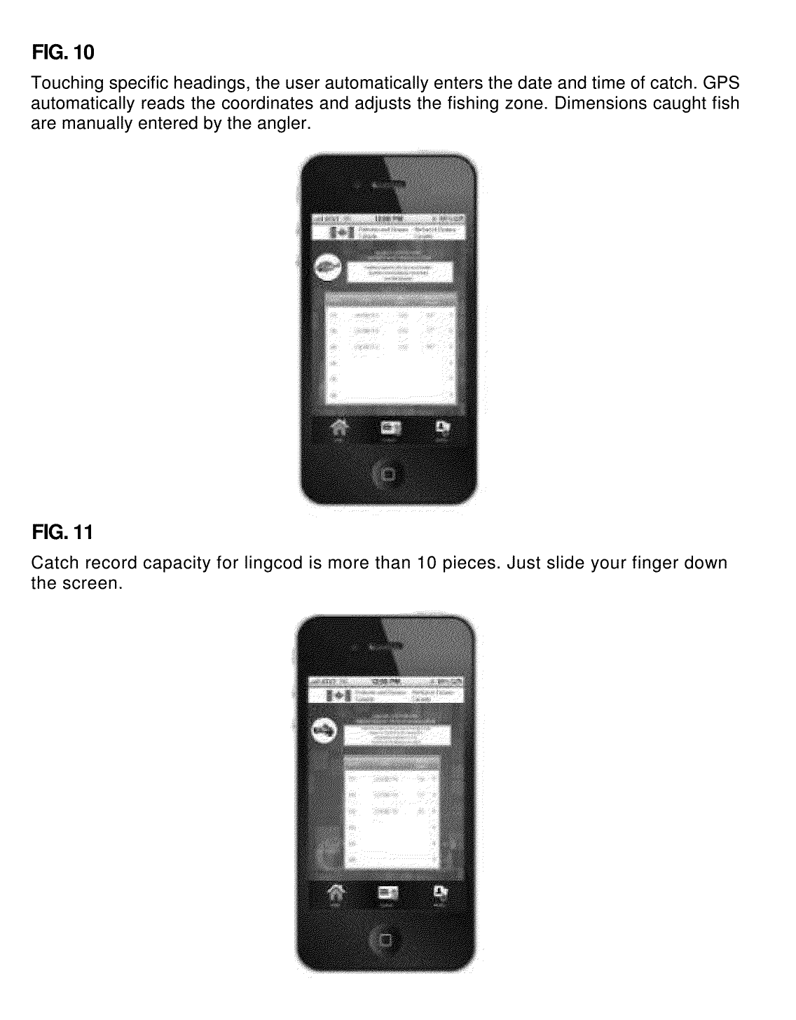

FIG. 10: Touching specific headings, the user automatically enters the date and time of catch. A GPS automatically reads the coordinates and matches the fishing zone. Dimensions caught fish are manually entered by the angler.

FIG. 11: Catch record capacity for lingcod is more than 10 pieces. Just slide your finger down the screen.

FIG. 12: Catch record capacity for Chinook salmon is more than 30 pieces. Just slide your finger down the screen.

FIG. 13: This option provides full access to the detailed terms of use with both the application itself and its license.

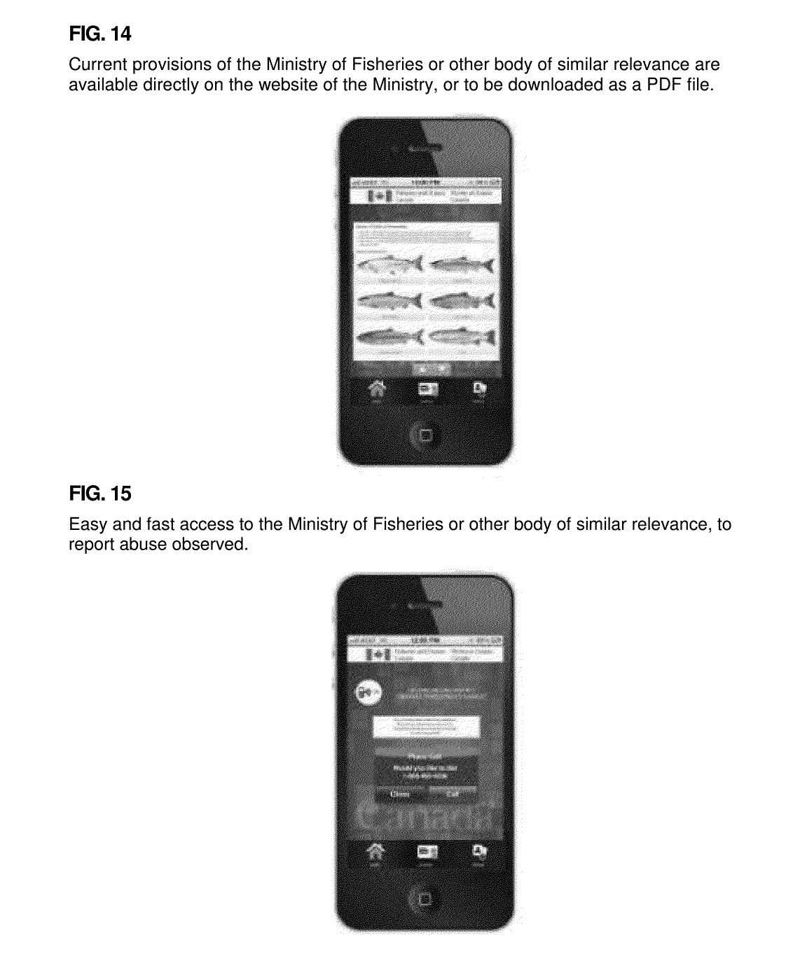

FIG. 14: Current provisions of the Ministry of Fisheries or other body of similar relevance are available directly on the website of the Ministry, or to be downloaded as a PDF file.

FIG. 15: Easy and fast access to the Ministry of Fisheries or other body of similar relevance, to report abuse observed.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. Method and system for generating identification and certification of e-licenses, containing communications solutions for the mutual exchange of information between the various elements of the system in the process of generating the identification and certification of e-licenses, characterized in that it uses Bluetooth wireless technology, an encrypted exchange of information with control authorities, and GPS to locate licensed areas, by date and time, and encryption algorithms to secure data transfer, username and password to prevent unauthorized use, and interface for exchange of information, applications, between the reader, computer and control bodies—the database.

2. A method for generating identification and certification of e-licensing according to claim 1, characterized in that the data in the system is replaced with the NFC technology, and the two-dimensional code scanning technology, for example qr codes, using scanners in smartphones, provides data transfer from the smartphone to the database of the controller and the data transfer is based on secure algorithms and data technologies with a unique secure identifier and using NFC/RFID identifier using authentication to verify validity of the license, adding security for the automatic reading and security verification.

3. A system for generating identification and certification of e-licenses, containing communications solutions for mutual exchange of information between the various elements of the system in the process of generating the identification and certification of e-licenses, characterized in that it is composed of a data concentrator 1 data management system, external certification systems 2, billing system 3, e-licenses in the form of an application 4, installed on an external device 5, for example, a computer and/or a smartphone.
